(19) United States
(12) Patent Application Publication
(10) Pub. No.: US 2025/0310995 A1
(43) Pub. Date: Oct. 2, 2025

(54) CODEBOOK BASED INTERFERENCE NULLING

(71) Applicant: Samsung Electronics Co., Ltd., Suwon-si (KR)

(72) Inventors: R A Nadisanka Perera Rupasinghe, McKinney, TX (US); Rui Huang, Vancouver (CA)

(21) Appl. No.: 19/066,115

(22) Filed: Feb. 27, 2025

Related U.S. Application Data
(60) Provisional application No. 63/570,160, filed on Mar. 26, 2024.

(51) Int. Cl. H04W 74/0816; H04B 7/06; H04L 5/00

(52) U.S. Cl. CPC H04W 74/0816; H04B 7/0639; H04L 5/0051

(57) ABSTRACT

A base station (BS) includes a processor configured to determine whether a transmission time interval (TTI) that includes joint transmission (JT) traffic for a first UE also includes non-JT traffic for a second UE. The BS also includes a transceiver operatively coupled to the processor. The transceiver is configured to in response to a determination that the TTI includes the non-JT traffic for the second UE, refrain from transmitting the JT traffic to the first UE during the TTI, and transmit the non-JT traffic to the second UE during the TTI while applying opportunistic nulling towards the first UE.

### CROSS-REFERENCE TO RELATED APPLICATION(S) AND CLAIM OF PRIORITY

This application claims priority under 35 U.S.C. § 119(e) to U.S. Provisional Patent Application No. 63/570,160 filed on Mar. 26, 2024. The above-identified provisional patent application is hereby incorporated by reference in its entirety.

### TECHNICAL FIELD

This disclosure relates generally to wireless networks. More specifically, this disclosure relates to codebook based interference nulling.

### BACKGROUND

For a cellular system operating in a low carrier frequency in general, for example a sub-1 GHz frequency range (e.g., less than 1 GHz), supporting a large number of channel state information-reference signal (CSI-RS) antenna ports (e.g., 32) or many antenna elements at a single location or remote radio head (RRH) is challenging due to a larger antenna form factor size needed for the carrier frequency wavelength compared to a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to the large number of CSI-RS antenna ports (such as 32) can't be achieved due to the antenna form factor limitation. One way to operate a system with large number of CSI-RS antenna ports at a low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

### SUMMARY

This disclosure provides apparatuses and methods for codebook based interference nulling.

In one embodiment, a base station (BS) is provided. The BS includes a processor configured to determine whether a transmission time interval (TTI) that includes joint transmission (JT) traffic for a first UE also includes non-JT traffic for a second UE. The BS also includes a transceiver operatively coupled to the processor. The transceiver is configured to, in response to a determination that the TTI includes the non-JT traffic for the second UE, refrain from transmitting the JT traffic to the first UE during the TTI, and transmit the non-JT traffic to the second UE during the TTI while applying opportunistic nulling towards the first UE.

In another embodiment, a method of operating a BS is provided. The method includes determining whether a TTI that includes JT traffic for a first UE also includes non-JT traffic for a second UE. The method also includes, in response to a determination that the TTI includes the non-JT traffic for the second UE, refraining from transmitting the JT traffic to the first UE during the TTI, and transmitting the non-JT traffic to the second UE during the TTI while applying opportunistic nulling towards the first UE.

In yet another embodiment, a non-transitory computer readable medium embodying a computer program is provided. The computer program includes program code that, when executed by a processor of a device, causes the device to determine whether a TTI that includes JT traffic for a first UE also includes non-JT traffic for a second UE, and in response to a determination that the TTI includes the non-JT traffic for the second UE: refrain from transmitting the JT traffic to the first UE during the TTI; select a codeword for transmission of the non-JT traffic to the second UE; and transmit, based on the selected codeword, the non-JT traffic to the second UE during the TTI while applying opportunistic nulling towards the first UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] B. Ghojogh, F Karray, and M. Crowley, ‘Eigenvalue and Generalized Eigenvalue Problems: Tutorial’, arXiv, May 2022
[2] Andre Tkacenko, P. P. Vaidyanathan, and Truong Q. Nguyen, ‘On the Eigenfilter Design Method and Its Applications: A Tutorial’, IEEE Trans. Analog & Digital Sig. Proc., September 2003
[3] A. Eremenko, “Simultaneous diagonalization of two quadratic forms and a generalized eigenvalue problem”, Perdue University, April 2020
[4] 3GPP TS 36.211 v16.4.0, “E-UTRA, Physical channels and modulation.”
[5] 3GPP TS 36.212 v16.4.0, “E-UTRA, Multiplexing and Channel coding.”
[6] 3GPP TS 36.213 v16.4.0, “E-UTRA, Physical Layer Procedures.”
[7] 3GPP TS 36.321 v16.3.0, “E-UTRA, Medium Access Control (MAC) protocol specification.”
[8] 3GPP TS 36.331 v16.3.0, “E-UTRA, Radio Resource Control (RRC) Protocol Specification.”
[9] 3GPP TS 38.211 v16.4.0, “NR, Physical channels and modulation.”
[10] 3GPP TS 38.212 v16.4.0, “NR, Multiplexing and Channel coding.”
[11] 3GPP TS 38.213 v16.4.0, “NR, Physical Layer Procedures for Control.”
[12] 3GPP TS 38.214 v16.4.0, “NR, Physical Layer Procedures for Data.”
[13] 3GPP TS 38.215 v16.4.0, “NR, Physical Layer Measurements.”
[14] 3GPP TS 38.321 v16.3.0, “NR, Medium Access Control (MAC) protocol specification.”
[15] 3GPP TS 38.331 v16.3.1, “NR, Radio Resource Control (RRC) Protocol Specification.”

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of CSI-RS port mapping according to embodiments of the present disclosure;

FIG. 5 illustrates an example of distributed MIMO according to embodiments of the present disclosure;

FIG. 6 illustrates another example of distributed MIMO according to embodiments of the present disclosure;

FIGS. 7A-7B illustrate examples of joint transmission according to embodiments of the present disclosure;

FIG. 8 illustrates an example of cell collaboration for joint transmission according to embodiments of the present disclosure;

FIG. 9 illustrates an example Type-I codebook according to embodiments of the present disclosure;

FIG. 10 illustrates an example operation to identify codeword correlation according to embodiments of the present disclosure;

FIG. 11 illustrates an example operation for codeword down selection according to embodiments of the present disclosure; and

FIG. 12 illustrates an example method for codebook based interference nulling according to embodiments of the present disclosure.

### DETAILED DESCRIPTION

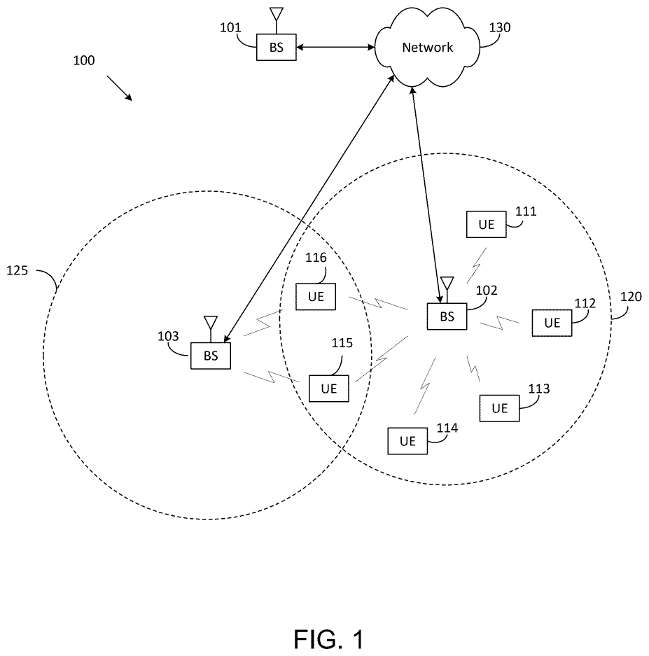

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for codebook based interference nulling. In certain embodiments, one or more of the gNBs 101-103 includes circuitry, programing, or a combination thereof, to support codebook based interference nulling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

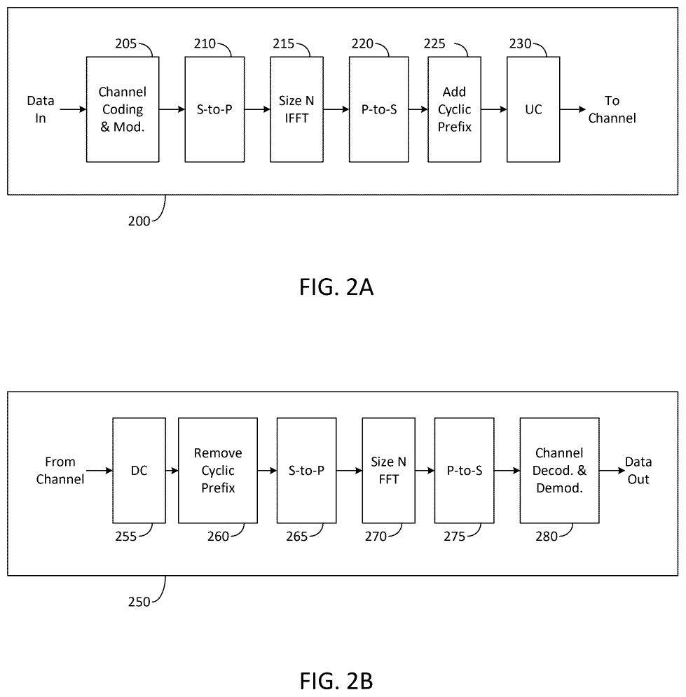

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support codebook based interference nulling as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

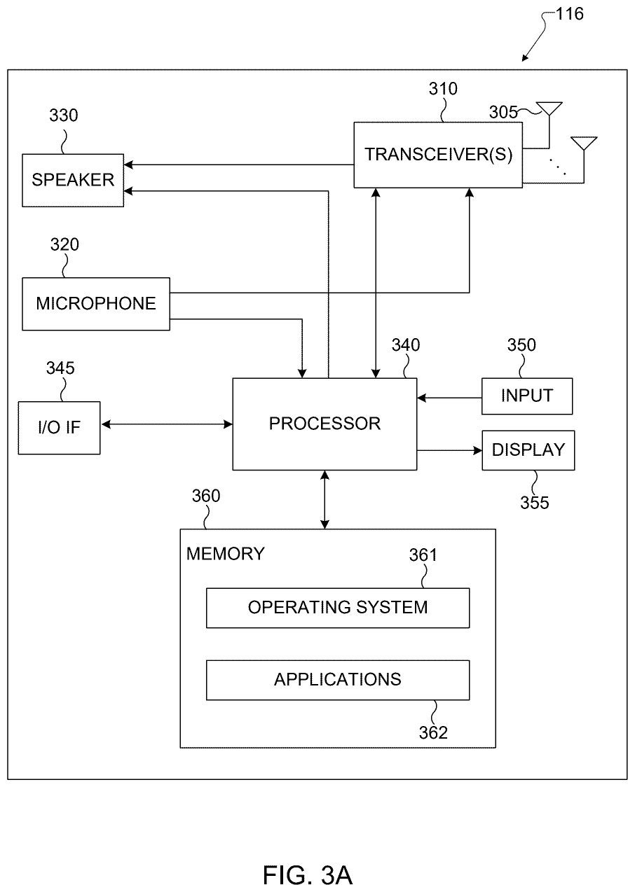

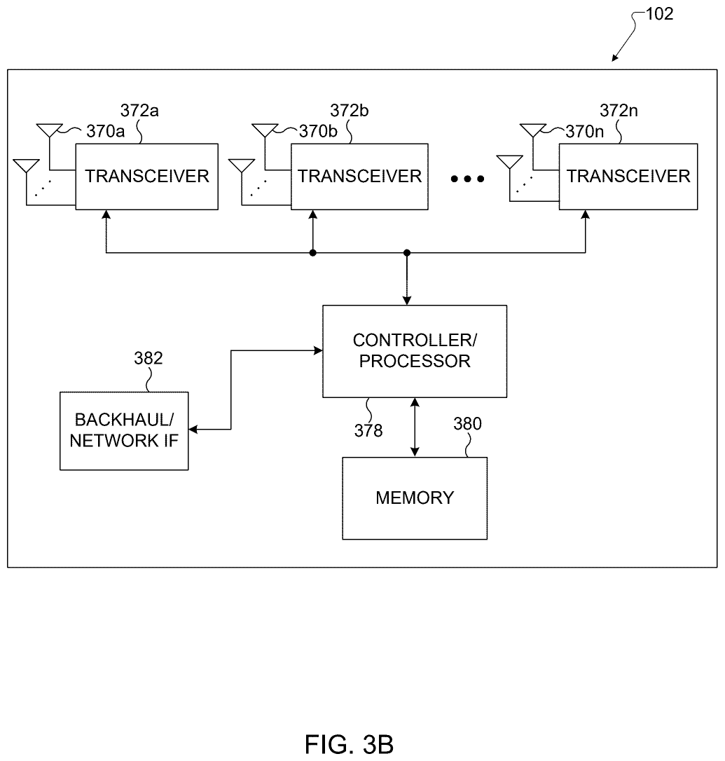

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for codebook based interference nulling as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support codebook based interference nulling as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

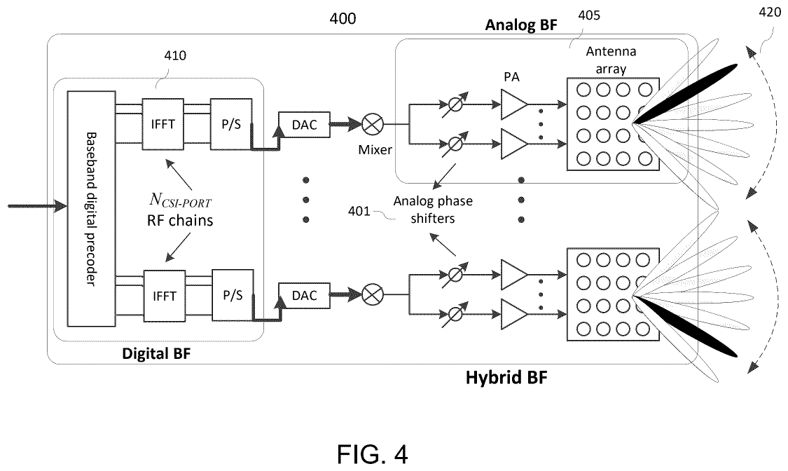

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports (which can correspond to the number of digitally precoded ports) tends to be limited due to hardware constraints (such as the feasibility to install a large number of ADCs/DACs at mmWave frequencies) as illustrated in FIG. 4.

FIG. 4 illustrates an example of CSI-RS port mapping 400 according to embodiments of the present disclosure. The embodiment of CSI-RS port mapping of FIG. 4 is for illustration only. Different embodiments of CSI-RS port mapping could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles (420) by varying the phase shifter bank across symbols or subframes. The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks (RBs). Receiver operation can be conceived analogously.

Although FIG. 4 illustrates one example of CSI-RS port mapping 400, various changes may be made to FIG. 4. For example, various changes to the number of beams could be made, the size of the antenna array, etc. according to particular needs.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger numbers of and sharper analog beams (hence larger number of radiators in the array) are used to compensate for the additional path loss.

At lower frequency bands such as FR1 or particularly the sub-1 GHz band, on the other hand, the number of antenna elements cannot be increased in a given form factor due to the large wavelength if a critical distance (≥λ/2) between two adjacent antenna elements is maintained in deployment scenarios. As an example, for the case of the wavelength size (λ) of the center frequency 600 MHz (which is 50 cm), 4 m is required for a uniform-linear-array (ULA) antenna panel of 16 antenna elements with the half-wavelength distance between two adjacent antenna elements. Considering a plurality of antenna elements is mapped to one digital port in practical cases, the required size for antenna panels at a gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limits the spectral efficiency of such systems.

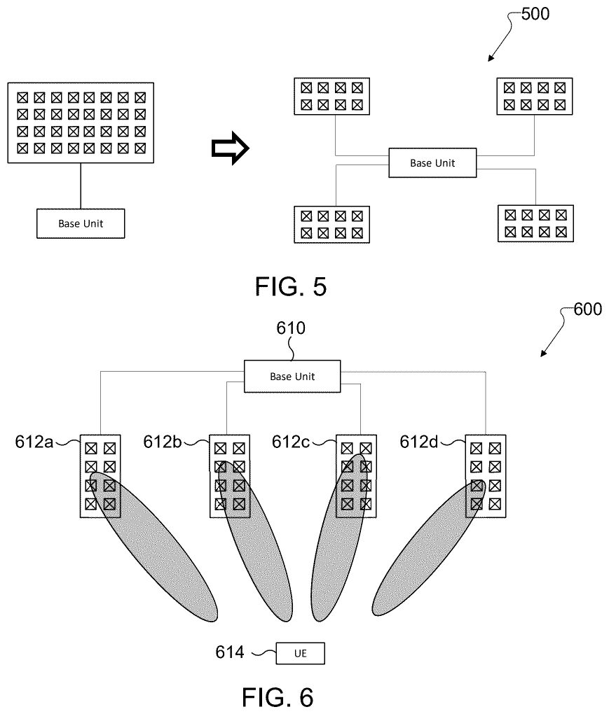

One possible approach to resolve the issue is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 5.

FIG. 5 illustrates an example of distributed MIMO 500 according to embodiments of the present disclosure. In the example of FIG. 5, distributed MIMO 500 is formed from multiple antenna panels, such as antenna modules or remote radio heads (RRHs), with a small number of antenna ports instead of integrating all the antenna ports in a single panel or at a single site and distributing the multiple panels in multiple locations/sites or RRHs. The example of FIG. 5 may be implemented by a BS. For instance, the example of distributed MIMO 500 may be implemented by one or more BSs such as BS 102. The example of distributed MIMO 500 is for illustration only and other embodiments can be used without departing from the scope of the present disclosure.

The multiple antenna panels at multiple locations can still be connected to a single base unit, and thus the signal transmitted/received via multiple distributed panels can be processed in a centralized manner through the single base unit, as illustrated in FIG. 6. In another embodiment, it is possible that multiple distributed antenna panels are connected to more than one base unit, which communicate with each other and jointly support the single antenna system.

FIG. 6 illustrates another example of distributed MIMO 600 according to embodiments of the present disclosure. In the example of FIG. 6, multiple antenna locations 612a-612d are connected to a single base unit 610. The base unit 610 may process signals transmitted and received via antenna locations 612a-612d in a centralized manner. For example, base unit 610 may process signals transmitted and received to UE 614. The example of FIG. 6 may be implemented by a BS. For example, the distributed MIMO 600 may be implemented by one or more BSs such as BS 102. The example of distributed MIMO 600 is for illustration only and other embodiments can be used without departing from the scope of the present disclosure.

In time division duplex (TDD) systems, an approach to acquire DL channel state information is to exploit UL channel estimation through receiving UL reference signals (RSs)(e.g., sounding reference signal [SRS]) sent from the UE. By using the channel reciprocity in TDD systems, the UL channel estimation itself can be used to infer DL channels. This favorable feature enables the network to reduce the training overhead significantly. However, due to the RF impairment at the transmitter and the receiver, directly using the UL channels for DL channels is not accurate and it requires a calibration process (periodically) among receive and transmit antenna ports of the RF network at the network. In general, the network has an on-board calibration mechanism in its own RF network to calibrate its antenna panels having a plurality of receiver/transmitter antenna ports, to enable DL/UL channel reciprocity in channel acquisition. The on-board calibration mechanism can be performed via small-power reference signal (RS) transmission and reception from/to the RF antenna network of the network, and thus calibration can be done according to the network's implementation in a confined manner (i.e., that does not interfere with other entities). However, it becomes difficult to perform the on-board calibration in distributed MIMO systems due to the distribution of the panels/RRHs over a wide region, and thus over-the-air (OTA) signaling mechanisms are utilized to calibrate receive/transmit antenna ports among multiple RRHs/panels far away in distributed MIMO.

Although low-band TDD systems are exemplified for motivation purposes, the present disclosure can be applied to any frequency band in FR1 and/or frequency division duplex (FDD) systems.

Precoder design is an important issue for distributed MIMO for enhancing received signal power and mitigating interference, especially when multiple UEs are scheduled together to share the same time, frequency, and power resources. In order to design the precoding for each scheduled user, explicit or implicit signaling is used to obtain the information about the UL/DL channel state information (CSI) between the antenna ports of transmitters and receivers. With such information about the UL/DL channels, the precoder for each UE can be properly derived to potentially maximize the signal-to-noise-plus-interference ratio (SINR) of the received signal, thereby achieving a higher throughput. However, the precoding design to achieve diversity gain in distributed MIMO may not always be available. In particular, a helping TRP may need to take care of its own traffic from time-to-time. When there is traffic at the helping TRP, the helping TRP needs to determine a precoder to minimize the interference level at the UE served with joint transmission (JT)(referred to as a JT UE) in a previous time slot. Otherwise, the JT UE will suffer not only from the loss of diversity gain but also from additional interference due to the helping TRP's transmission to its own UE.

For example, in main cell JT, co-ordination handshaking between a serving and helping cells for JT takes place approx. every 0.5 seconds. After a successful handshake, the serving cell assumes JT is available uninterruptedly for a JT UE. However, as noted above, a helping cell may need to take care of its own traffic from time-to-time. This may result in some transmission time intervals (TTIs) with no JT from the helping cell. In these circumstances (referred to as a JT failure event), the helping cell becomes an interferer, and the JT failure event may result in a packet drop, impacting the overall link adaptation process. This may result in a reduced rank indicator (RI)/modulation coding scheme (MCS) for the JT UE.

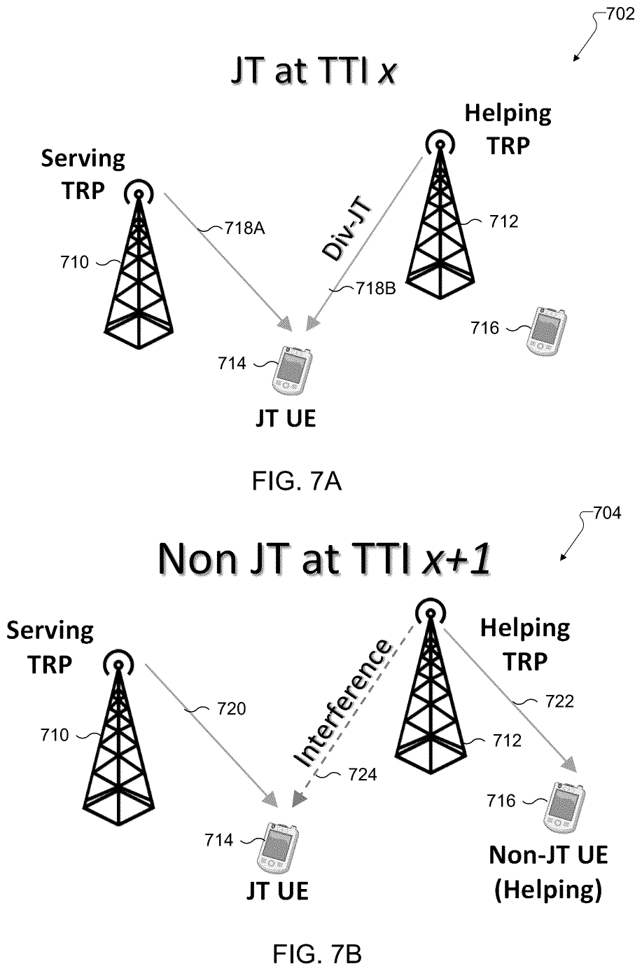

FIGS. 7A-7B illustrate examples 702 and 704 of joint transmission according to embodiments of the present disclosure. The embodiment of joint transmission of FIGS. 7A-7B is for illustration only. Different embodiments of joint transmission could be used without departing from the scope of this disclosure.

In example 702 shown in FIG. 7A, a JT is performed at a TTI x. At TTI x, a BS 710 is acting as a serving TRP, and a BS 712 is acting as a helping TRP for a JT UE 714. During TTI x, BS 710 transmits a signal 718A and BS 712 transmits a signal 718B to JT UE 714 according to divided-JT (Div-JT) operation. BS 712 does not transmit any signals to non-JT UE 716, which is served by BS 712, at TTI x.

In example 702 shown in FIG. 7B, various non-joint transmissions are performed at a TTI x+1. In example 702, BS 710 presumes that BS 712 is available to perform a JT toward JT UE 714, and BS 710 transmits a signal 720 toward JT UE 714. However, BS 712 has traffic for non-JT UE 716, and BS 712 transmits a signal 722 toward non-JT UE 716. This results in interference 724 interfering with signal 720.

Although FIGS. 7A-7B illustrate examples 702 and 704 of joint transmission, various changes may be made to FIGS. 7A-7B. For example, the joint transmission could include additional TRPs, occur at different TTIs, etc. according to particular needs.

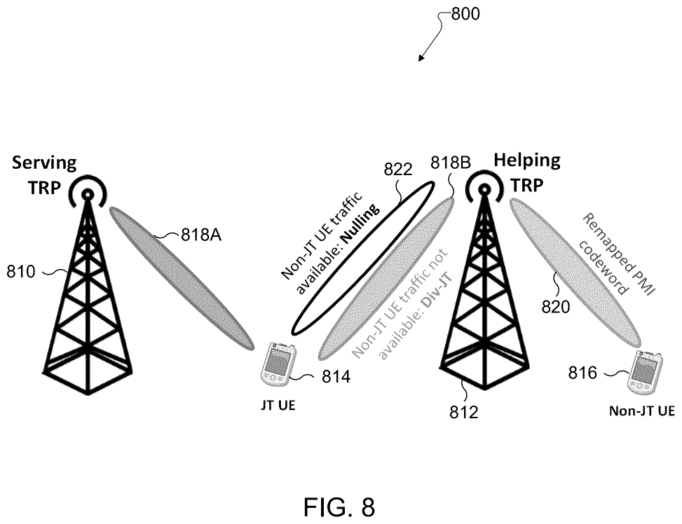

To provide improved coverage in situations where a helping cell has non-JT traffic, various embodiments of the present disclosure provide for codebook based precoder determination at the helping TRP when the helping TRP serves its own UE. The precoder determination targets minimizing interference (e.g., via opportunistic nulling) at the JT UE (referred to herein as codebook based interference nulling). An example of codebook based interference nulling is shown in FIG. 8.

FIG. 8 illustrates an example 800 of cell collaboration for joint transmission according to embodiments of the present disclosure. The embodiment of cell collaboration for joint transmission of FIG. 8 is for illustration only. Different embodiments of cell collaboration for joint transmission could be used without departing from the scope of this disclosure.

In example 800, a BS 810 is acting as a serving TRP, and a BS 812 is acting as a helping TRP for a JT UE 814. For any particular TTI interval, BS 710 presumes that BS 712 is available to perform a JT toward JT UE 714, and BS 710 may transmit a signal 818A toward JT UE 814. For a TTI where BS 812 does not have traffic for non-JT UE 816, BS 712 transmits a signal 818B to JT UE 814 according to Div-JT operation.

For a TTI where BS 812 has traffic for non-JT UE 816, BS 812 transmits a signal 820 to non-JT UE 816 based on a remapped precoding matrix indicator (PMI) codeword, \tilde{W}_{non-JT}(N_{TX}×RI_{Non-JT}). The remapped codeword is identified to minimize leakage towards JT UE 814 while maximizing gain at non-JT UE 816 (e.g., codebook based interference nulling). This results in interference nulling 822 of signal 818A toward JT UE 814.

Although FIG. 8 illustrates one example 800 of cell collaboration for joint transmission, various changes may be made to FIG. 8. For example, cell collaboration for joint transmission could include additional different TRPs, include interference nulling for transmissions to additional UEs, etc. according to particular needs.

In example 800, it is assumed that BS 812 has sounding reference signal (SRS) channel information of JT UE 814, H₂(N_{RX}×N_{TX}×N_{RB}), while for non-JT UE 816, only the reported precoding matrix indicator (PMI), W̅_{CB} (RI×N_{TX}) is available to BS 812.

In some embodiments, the reported PMI of non-JT UE 816 can be approximated to its channel as,

$${W}_{CB}^{H} ( {RI}_{Non - JT} \times {N}_{T X} ) \approx {\tilde{H}}_{n on - JT} .$$

In these embodiments, identification of the remapped PMI codeword \tilde{W}_{non-JT}(N_{TX}×RI_{Non-JT}) can be re-formulated as a non-JT UE 816 precoder determination constraint on a leakage threshold at JT UE 814 as follows:

$${\tilde{W}}_{n o n - J T} ( {N}_{T X} \times {RI}_{N o n - J T} ) = {arg max}_{p} \frac{Tr \{ {{P}^{H} ( {\tilde{H}}_{non - JT} )}^{H} {\tilde{H}}_{non - JT} P \}}{{\sum }_{j = 1}^{{N}_{R B}} Tr \{ {{P}^{H} ( {H}_{2} ( j ) )}^{H} {H}_{2} ( j ) P \}} = {arg max}_{P} \frac{\frac{1}{{N}_{RB}} Tr \{ {{P}^{H} ( {\tilde{H}}_{non - JT} )}^{H} {\tilde{H}}_{non - JT} P \}}{Tr \{ {P}^{H} {R}_{2} P \}} ; {R}_{2} = \frac{1}{{N}_{RB}} {\sum }_{j = 1}^{{N}_{RB}} {( {H}_{2} ( j ) )}^{H} {H}_{2} ( j ) \qquad ( 1 )$$

subject to:

$$T r \{ {P}^{H} {R}_{2} P \} \leq {γ}_{t h} \qquad ( 1 ‐ 1 )$$

$$Tr \{ {P}^{H} P \} = {RI}^{k} \qquad ( 1 ‐ 2 )$$

$${{P}^{H} ( {\tilde{H}}_{non - JT} )}^{H} {\tilde{H}}_{non - JT} P = {D}^{k} ( diagonal matrix ) \qquad ( 1 ‐ 3 )$$

Considering spatial covariance

$${R}_{2} = \frac{1}{{N}_{R B}} {\sum }_{j = 1}^{{N}_{R B}} {( {H}_{2} ( j ) )}^{H} {H}_{2} ( j )$$

derived based on JT UE 814's SRS channel information, H₂, an eigen value decomposition of R₂ can be given as follows:

$${R}_{2} = {U}_{2} {\sum }_{2} {U}_{2}^{H} {U}_{2} = [ {U}_{2}^{*} {U}_{2}^{( 0 )} ] \qquad ( 2 )$$

where

$${U}_{2}^{*} ( {N}_{T X} \times {r}^{*} )$$

is a matrix collecting r*number of dominant eigen vectors with non-zero eigenvalues of R₂. Further,

$${U}_{2}^{( 0 )} ( {N}_{T X} \times ( {N}_{T X} - {r}^{*} ) )$$

is a matrix collecting the rest of the eigen vectors.

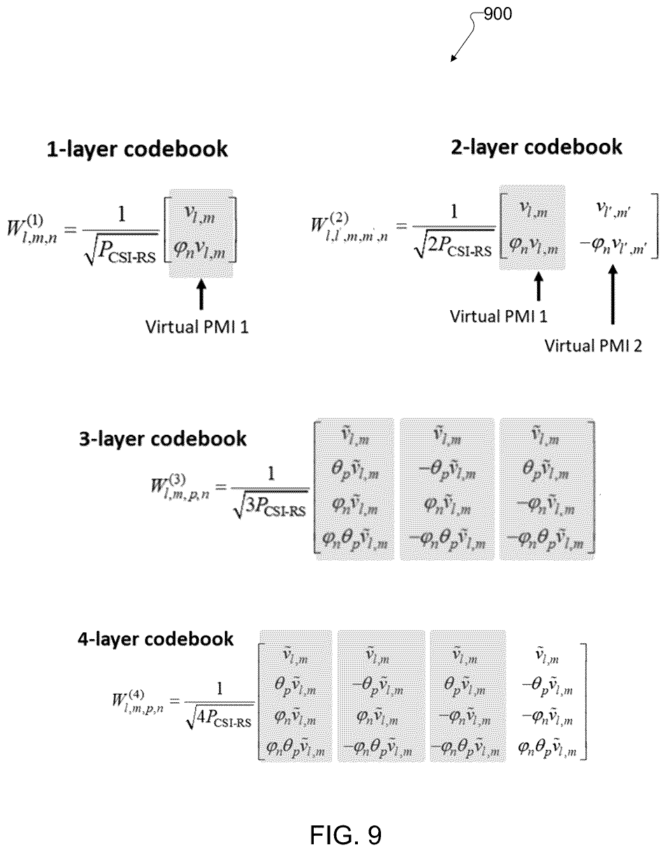

In view of the above, let a Type-I codebook for [symbol] number of layers be, [symbol] , [symbol] ∈{1, 2, 3, 4} having [symbol] number of codewords. For example, 4 different codebooks can be given as shown in FIG. 9. Note that, as shown in FIG. 9, each codeword in the Type-I codebook [symbol] is separated into multiple virtual PMIs. In particular, there are [symbol] virtual PMIs per codeword in the Type-I codebook [symbol] .

FIG. 9 illustrates an example Type-I codebook 900 according to embodiments of the present disclosure. The embodiment of a Type-I codebook of FIG. 9 is for illustration only. Different embodiments of a Type-I codebook could be used without departing from the scope of this disclosure.

In the example of FIG. 9, Type-I codebook 900 includes 4 different codebooks. Each precoder in a [symbol] -layers, [symbol] ∈{1, 2, 3, 4} codeword is identified as a virtual precoder. Hence, there are [symbol] virtual PMIs per codeword.

Although FIG. 9 illustrates one example Type-I codebook 900, various changes may be made to FIG. 9. For example, various changes to number of layers could be made, etc. according to particular needs.

In some embodiments, a two-step approach may be used for identifying the new codeword (i.e., the remapped codeword \tilde{W}_{non-JT}(N_{TX}×RI_{Non-JT})) from a Type-I codebook (such as Type-I codebook 900) to transmit to non-JT UE 816 while achieving interference nulling at JT UE 814. In these embodiments, the first step may be a codeword down selection operation, and the second step may be a code word matching operation.

In some embodiments, a codeword down selection operation may be performed as follows:

Considering the eigen value decomposition of spatial covariance R₂ in equation (2) above, by projecting the matrix

$${U}_{2}^{*}$$

on to the Type-I codebook [symbol] , [symbol] ∈{1, 2, 3, 4}, codewords of the l-th layers codebook having the highest correlation to eigen directions in the matrix

$${U}_{2}^{*}$$

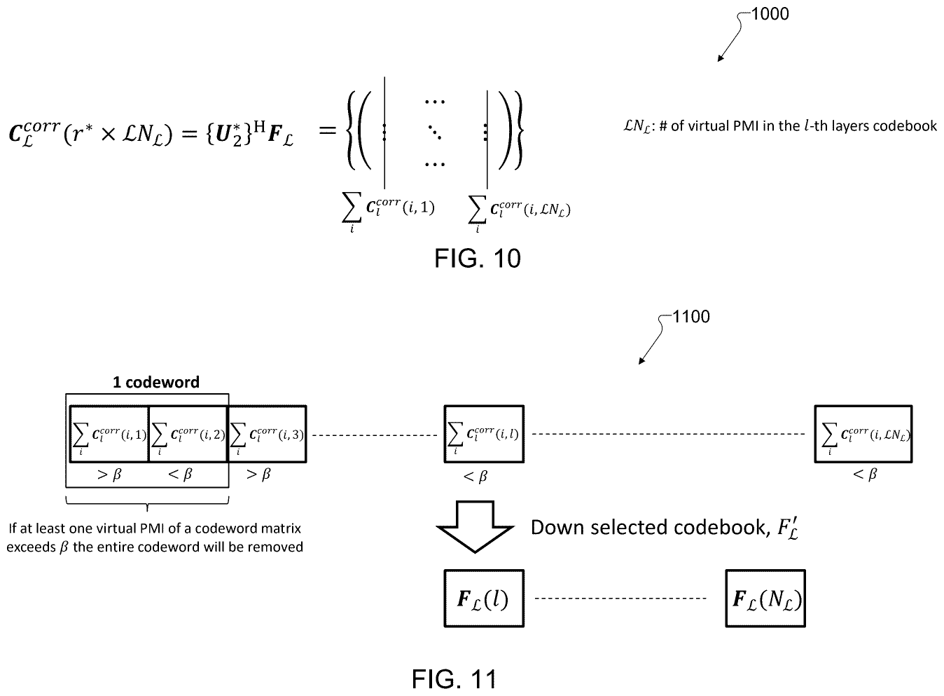

can be identified as shown in FIG. 10.

FIG. 10 illustrates an example operation 1000 to identify codeword correlation according to embodiments of the present disclosure. The embodiment of an operation to identify codeword correlation of FIG. 10 is for illustration only. Different embodiments of an operation to identify codeword correlation could be used without departing from the scope of this disclosure.

In operation 1000, column-wise summation provides a total correlation of a particular codeword with all eigen directions in the matrix U₂*. For instance,

$${\sum }_{i} {C}_{l}^{c o r r} ( i , 1 )$$

is the total correlation of the 1st virtual PMI in Type-I codebook [symbol] to all eigen directions in the matrix

$${U}_{2}^{*} .$$

In some embodiments, β may represent a maximum allowable total correlation between the matrix

$${U}_{2}^{*}$$

and a codeword in Type-I codebook [symbol] . In some embodiments, β may be a pre-defined value. In some embodiments, a set of values may be defined and one the values from the set may be selected as β based on at least one criterion.

Considering β, in some embodiments a new codebook, down selected codebook [symbol] with codewords having total correlation less than or equal to β can be determined for [symbol] =2 (2−layer codebook) as shown in FIG. 11.

FIG. 11 illustrates an example operation 1100 for codeword down selection according to embodiments of the present disclosure. The embodiment of an operation for codeword down selection of FIG. 11 is for illustration only. Different embodiments of an operation for codeword down selection could be used without departing from the scope of this disclosure.

In the example of FIG. 11, for [symbol] =2, a down selected codebook

$${F}_{2}^{′}$$

is identified with codewords having correlation to both virtual PMIs smaller than β. If at least one of the virtual PMIs in a codeword exceeds β, the entire codeword is removed.

Although FIG. 11 illustrates one example operation 1100 for codeword down selection, various changes may be made to FIG. 11. For example, the codeword down selection could be for any [symbol] -th layer codebook, etc. according to particular needs.

Codeword down selection removes all the highly correlated eigen directions to the dominant eigen space of the spatial covariance R₂. Hence, all the remaining codewords in the down selected codebook

$${F}_{ℒ}^{′}$$

are sufficiently less correlated to the dominant eigen space of the spatial covariance R₂. The number of codewords in the down selected codebook

$${F}_{ℒ}^{′}$$

is

$${N}_{ℒ}^{′} \leq {N}_{ℒ} .$$

Note that in some embodiments, codewords in an [symbol] -th layer codebook can be included in an [symbol] +1-th layer codebook as well. For instance, in the examples of FIG. 10 and FIG. 11, [symbol] can be either 1 or 3. In some embodiments, if any of the codewords in an [symbol] -th layer codebook are removed during the codeword down selection step, corresponding codewords in an [symbol] +1-th layer codebook are also removed before initiating down selection.

The codeword down selection step is repeated for codebooks associated with all layers. After the completion of codeword down selection step, the updated codebooks for different layers [symbol] ∈{1, 2, 3, 4} is the down selected codebook

$${F}_{ℒ}^{′} , ℒ ∈ \{ 1 , 2 , 3 , 4 \} .$$

In some embodiments, to reduce complexity, non-JT UE 416's rank is fixed to the reported rank. In these embodiments, only the down selected codebook of the reported rank is identified.

In some embodiments, given the down selected codebook

$${F}_{ℒ}^{′} , ℒ ∈ \{ 1 , 2 , 3 , 4 \} ,$$

as the output of a codeword down selection operation, a codeword having the highest correlation to a PMI codeword W̅_{CB} reported by non-JT UE 816 is identified as the new codeword during the codeword matching operation. The codeword matching operation may be performed as follows:

In some embodiments, a codeword from the down selected codebook,

$${F}_{ℒ}^{′} ,$$

associated with a rank indication (RI) reported by non-JT UE 816, is identified as the new codeword. For example, for a non-JT UE 816 reported rank l∈{1, 2, 3, 4}, the associated down selected codebook is

$${F}_{l}^{′} .$$

In some embodiments, to determine the codeword with the highest correlation in down selected codebook

$${F}_{l}^{′}$$

to a reported PMI, W_{CB}, a set of pre-defined correlation lookup tables can be utilized. An example pre-defined correlation lookup table is shown in Table 1.

TABLE 1
Example correlation table for 1-layer and 2-layer codewords

| Index | Value |
|---|---|
| 0 | 0.2500 |
| 1 | 0.2134 |
| 2 | 0.1250 |
| 3 | 0.0366 |
| 4 | 0.2033 |
| 5 | 0.1735 |
| 6 | 0.1016 |
| 7 | 0.0298 |
| 8 | 0.1026 |
| 9 | 0.0876 |
| 10 | 0.0513 |
| . . . | . . . |
| 56 | 0.0041 |
| 57 | 0.0035 |
| 58 | 0.0020 |
| 59 | 0.0006 |
| 60 | 0.0020 |
| 61 | 0.0017 |
| 62 | 0.0010 |
| 63 | 0.0003 |

In some embodiments, these correlation look-up tables capture correlation between two virtual PMIs from a Type-I codebook. In some embodiments, the correlation between two virtual PMIs can be calculated by calculating the inner product between the virtual PMIs.

In some embodiments, for every codeword,

$${W}_{CB}^{l} ( n )$$

in the down selected codebook

$${F}_{l}^{′}$$

with

$${W}_{CB}^{l} \neq {\overline{W}}_{CB}$$

and n∈{1, . . . , Nₗ} the following correlation metric is then calculated:

$${r}_{l}^{c o r r} ( n ) = {r}_{l}^{c o r r} ( 1 , n ) \times {r}_{l}^{c o r r} ( 2 , n ) … \times {r}_{l}^{c o r r} ( l , n ) \qquad ( 3 )$$

where

$${r}_{l}^{corr} ( k , n )$$

is the correlation between the k-th layer precoder from the reported PMI codeword W̅_{CB} and the n-th codeword,

$${W}_{CB}^{l} ( n )$$

of the down selected codebook

$${F}_{l}^{′} .$$

For every codeword in the down selected codebook

$${F}_{l}^{′} ,$$

a correlation metric is calculated as per equation (3):

$$\{ {r}_{l}^{c o r r} ( 1 ) , {r}_{l}^{c o r r} ( 2 ) … {r}_{{N}_{l}}^{c o r r} ( {N}_{{l}^{′}} ) \}$$

where [symbol] is the number of codewords in down selected codebook

$${F}_{ℒ}^{′} .$$

Subsequently, the codeword n* with the highest correlation from the down selected codebook

$${F}_{l}^{′}$$

is identified as,

$${n}^{*} = arg {max}_{n} \{ {r}_{l}^{c o r r} ( 1 ) , {r}_{l}^{c o r r} ( 2 ) … {r}_{l}^{c o r r} ( {N}_{{l}^{′}} ) \} \qquad ( 4 )$$

Finally, the new precoder (i.e., codeword) for non-JT UE 816 is identified as

$${W}_{CB}^{l} ( {n}^{*} )$$

from the down selected codebook

$${F}_{l}^{′} .$$

For example, if the reported PMI, W_{CB} is from a 2-layer codebook, two virtual PMIs are available, and the new precoder may be determined as follows:

For every codeword,

$${W}_{CB}^{n}$$

in

$${F}_{2}^{′}$$

with

$${W}_{CB}^{n} \neq {W}_{CB}$$

and n∈{1, . . . , [symbol] } the following correlation metric is calculated

$${r}_{n}^{corr} = {r}_{1 , n}^{corr} \times {r}_{2 , n}^{corr} .$$

$${r}_{1 , n}^{corr} and {r}_{2 , n}^{corr}$$

can readily be calculated from look-up tables as in Fast MU.

$${n}^{*} = arg {max}_{n} \{ {r}_{1}^{c o r r} , {r}_{2}^{c o r r} … {r}_{{N}_{{ℒ}^{′}}}^{c o r r} \} .$$

This results in the matched PMI

$${\tilde{W}}_{non - JT} = {W}_{CB}^{{n}^{*}} .$$

In some embodiments, the new precoder for non-JT UE 816 is determined based on a pre-defined rank, l̅(≤l). In these embodiments, when determining a codeword from the down selected codebook

$${F}_{\overline{l}}^{′} ,$$

precoders associated with the first l̅ layers in the reported PMI codeword W̅_{CB} are considered. A similar approach as discussed herein is then provided for identifying the new codeword from the down selected codebook

$${F}_{\overline{l}}^{′} .$$

In some embodiments, the new precoder for non-JT UE 816 is determined by looking at all codebooks with a rank smaller than a non-JT UE 416 reported rank, l. In particular, as discussed previously herein, for every down selected codebook,

$${F}_{ℒ}^{′} ,$$

with [symbol] ≤l, one codeword is selected considering the two-step approach described herein. Subsequently, based on at least one criterion, the best codeword out of the selected codewords from each down selected codebook

$${F}_{ℒ}^{′} ,$$

with [symbol] ≤l, is selected as the new codeword, and each down selected codebook

$${F}_{ℒ}^{′}$$

equal to the rank of the selected new codeword is updated.

In some embodiments, the best codeword is selected considering the sum rate. By approximating W̅_{CB} to non-JT UE 816's channel, the sum rate across layers of each selected code word from each down selected codebook

$${F}_{ℒ}^{′}$$

with [symbol] ≤l is calculated. Afterwards, the codeword and associated rank maximizing the sum rate is selected as the new precoder for non-JT UE 816.

The example 800 of cell collaboration for joint transmission of FIG. 8 can be summarized according to the following algorithm:

If non-JT UE traffic available:

| - | Input: W_{CB}^{H} - Type-I PMI of non-JT UE; H₂ - RB-level SRS channel of JT UE | |
|---|---|---|
| - | Calculate R₂ from H₂ | |
| - | If d{R₂, R̅₂} ≤ β and W_{CB}^{H} is not updated (where d{X₁, X₂} is a distance metric to find | |
| | similarity between X₁, X₂ matrices) | |
| | ∘ | \tilde{W}_{non-JT} is not updated and is the same as what is calculated previously |
| - | Else | |
| | ∘ | Step 1: Derive U₂* from equation (3) |
| | ∘ | Step 2: Identify [symbol] ( [symbol] is equivalent to reported rank) considering Codeword down |
| | | selection criteria |
| | ∘ | Step 3: Identify r₁^{corr}, r₂^{corr} ... [symbol] from equation (3) for each codeword in [symbol] |
| | ∘ | Step 4: Identify n* from equation (4) |
| | ∘ | Step 5: \tilde{W}_{non-JT} = W_{CB}ⁿ* where W_{CB}ⁿ* is from [symbol] |

If non-JT UE traffic not available
Input: H₂ - RB-level SRS channel of JT UE
Derive zero-forcing (ZF) precoders W₂ from H₂ for JT UE
Output:W₂

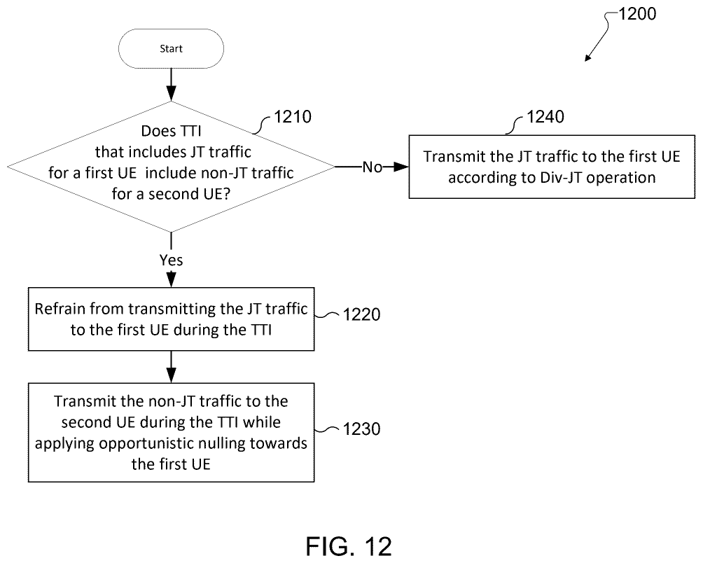

FIG. 12 illustrates an example method 1200 for codebook based interference nulling according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for codebook based interference nulling could be used without departing from the scope of this disclosure.

In the example of FIG. 12, method 1200 begins at step 1210. At step 1210, a BS (such as BS 812 of FIG. 8) determines whether a TTI that includes JT traffic for a first UE (such as JT UE 814 of FIG. 8) also includes non-JT traffic for a second UE (such as non-JT UE 816 of FIG. 8). If the TTI includes non-JT traffic for the second UE, method 1200 proceeds to step 1220. Otherwise, if the TTI does not include non-JT traffic for the second UE, method 1200 proceeds to step 1240.

At step 1220, the BS refrains from transmitting the JT traffic to the first UE during the TTI.

At step 1230, the BS transmits the non-JT traffic to the second UE during the TTI while applying opportunistic nulling towards the first UE.

In some embodiments, the BS selects a codeword for transmission of the non-JT traffic to the second UE, and the non-JT traffic is transmitted to the second UE based on the selected codeword.

In some embodiments, to select the codeword, the BS (i) receives a PMI codeword reported by the second UE, (ii) down selects codewords from a first codebook to determine a second codebook, and (iii) identifies a codeword from the second codebook having a highest correlation to the PMI codeword reported by the second UE as the selected codeword.

In some embodiments, to down select the codewords from the first codebook to determine the second codebook, the BS (i) receives, from the first UE, an SRS, (ii) determines, based on the SRS, a spatial covariance of the first UE, and (iii) down selects the codewords from the first codebook based on a correlation between the codewords from the first codebook and dominant eigen vectors of the spatial covariance.

In some embodiments, the selected codeword is selected from a pre-defined lookup table.

In some embodiments, to select the codeword, the BS (i) receives a PMI codeword reported by the second UE, (ii) determines a pre-defined rank l̅ less than or equal to a reported rank of the second UE, and (iii) identifies a codeword from precoders associated with first l̅ layers in the PMI codeword having a highest correlation to the PMI codeword reported by the second UE as the selected codeword.

In some embodiments, to select the codeword, the BS (i) receives a PMI codeword reported by the second UE, (ii) for each a plurality of codebooks for each rank less than a reported rank of the second UE, identifies a codeword having a highest correlation to the PMI codeword reported by the second UE, and (iii) determines a best codeword from the codewords identified from the plurality of codebooks as the selected codeword.

In some embodiments, to select the codeword, the BS (i) receives a PMI codeword reported by the second UE, (ii) for each of a plurality of codebooks for each rank less than a reported rank of the second UE, identifies a codeword having a highest correlation to the PMI codeword reported by the second UE, (iii) approximates the PMI codeword to a channel of the second UE sum rate across layers of each identified codeword from the plurality of codebooks, and (iv) determines a codeword from the codewords identified from the plurality of codebooks having a highest sum rate as the selected codeword.

At step 1240, the BS transmits the JT traffic to the first UE according to Div-JT operation.

Although FIG. 12 illustrates one example method 1200 for codebook based interference nulling, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a processor configured to:
determine whether a transmission time interval (TTI) that includes joint transmission (JT) traffic for a first UE also includes non-JT traffic for a second UE;
a transceiver operatively coupled to the processor, the transceiver configured to, in response to a determination that the TTI includes the non-JT traffic for the second UE:
refrain from transmitting the JT traffic to the first UE during the TTI; and
transmit the non-JT traffic to the second UE during the TTI while applying opportunistic nulling towards the first UE.

2. The BS of claim 1, wherein:
the processor is further configured to select a codeword for transmission of the non-JT traffic to the second UE; and
the transceiver is further configured to transmit the non-JT traffic to the second UE based on the selected codeword.

3. The BS of claim 2, wherein to select the codeword:
the transceiver is further configured to receive a PMI codeword reported by the second UE; and
the processor is further configured to:
down select codewords from a first codebook to determine a second codebook; and
identify a codeword from the second codebook having a highest correlation to the PMI codeword reported by the second UE as the selected codeword.

4. The BS of claim 3, wherein to down select codewords from the first codebook to determine the second codebook:
the transceiver is further configured to receive, from the first UE, a sounding reference signal (SRS); and
the processor is further configured to:
determine, based on the SRS, a spatial covariance of the first UE; and
down select the codewords from the first codebook based on a correlation between the codewords from the first codebook and dominant eigen vectors of the spatial covariance.

5. The BS of claim 4, wherein the selected codeword is selected from a pre-defined correlation lookup table.

6. The BS of claim 2, wherein to select the codeword:
the transceiver is further configured to receive a PMI codeword reported by the second UE; and
the processor is further configured to:
determine a pre-defined rank l̅ less than or equal to a reported rank of the second UE; and
identify a codeword from precoders associated with first l̅ layers in the PMI codeword having a highest correlation to the PMI codeword reported by the second UE as the selected codeword.

7. The BS of claim 2, wherein to select the codeword:
the transceiver is further configured to receive a PMI codeword reported by the second UE; and
the processor is further configured to:
for each of a plurality of codebooks for each rank less than a reported rank of the second UE, identify a codeword having a highest correlation to the PMI codeword reported by the second UE; and
determine a best codeword from the codewords identified from the plurality of codebooks as the selected codeword.

8. The BS of claim 2, wherein to select the codeword:
the transceiver is further configured to receive a PMI codeword reported by the second UE; and
the processor is further configured to:
for each of a plurality of codebooks for each rank less than a reported rank of the second UE, identify a codeword having a highest correlation to the PMI codeword reported by the second UE; and
approximate the PMI codeword to a channel of the second UE to calculate a sum rate across layers of each identified codeword from the plurality of codebooks; and
determine a codeword from the codewords identified from the plurality of codebooks having a highest sum rate as the selected codeword.

9. The BS of claim 1, wherein the transceiver is further configured to, in response to a determination that the TTI does not include non-JT traffic for the second UE, transmit the JT traffic to the first UE according to divided-JT (Div-JT) operation.

10. A method of operating a base station (BS), the method comprising:
determining whether a transmission time interval (TTI) that includes joint transmission (JT) traffic for a first UE also includes non-JT traffic for a second UE; and
in response to a determination that the TTI includes the non-JT traffic for the second UE:
refraining from transmitting the JT traffic to the first UE during the TTI; and
transmitting the non-JT traffic to the second UE during the TTI while applying opportunistic nulling towards the first UE.

11. The method of claim 10, further comprising selecting a codeword for transmission of the non-JT traffic to the second UE,
wherein the non-JT traffic is transmitted to the second UE based on the selected codeword.

12. The method of claim 11, wherein selecting the codeword further comprises:
receiving a PMI codeword reported by the second UE;
down selecting codewords from a first codebook to determine a second codebook; and
identifying a codeword from the second codebook having a highest correlation to the PMI codeword reported by the second UE as the selected codeword.

13. The method of claim 12, wherein down selecting codewords from the first codebook to determine the second codebook further comprises:
receiving, from the first UE, a sounding reference signal (SRS);
determining, based on the SRS, a spatial covariance of the first UE; and
down selecting the codewords from the first codebook based on a correlation between the codewords from the first codebook and dominant eigen vectors of the spatial covariance.

14. The method of claim 13, wherein the selected codeword is selected from a pre-defined correlation lookup table.

15. The method of claim 11, wherein selecting the codeword, further comprises:
receiving a PMI codeword reported by the second UE;
determining a pre-defined rank l̅ less than or equal to a reported rank of the second UE; and
identifying a codeword from precoders associated with first l̅ layers in the PMI codeword having a highest correlation to the PMI codeword reported by the second UE as the selected codeword.

16. The method of claim 11, wherein selecting the codeword, further comprises:
receiving a PMI codeword reported by the second UE;
for each of a plurality of codebooks for each rank less than a reported rank of the second UE, identifying a codeword having a highest correlation to the PMI codeword reported by the second UE; and
determining a best codeword from the codewords identified from the plurality of codebooks as the selected codeword.

17. The method of claim 11, wherein selecting the codeword, further comprises:
receiving a PMI codeword reported by the second UE;
for each of a plurality of codebooks for each rank less than a reported rank of the second UE, identifying a codeword having a highest correlation to the PMI codeword reported by the second UE;
approximating the PMI codeword to a channel of the second UE to calculate a sum rate across layers of each identified codeword from the plurality of codebooks; and
determining a codeword from the codewords identified from the plurality of codebooks having a highest sum rate as the selected codeword.

18. The method of claim 10, further comprising, in response to a determination that the TTI does not include non-JT traffic for the second UE, transmitting the JT traffic to the first UE according to divided-JT (Div-JT) operation.

19. A non-transitory computer readable medium embodying a computer program comprising program code that, when executed by a processor of a device, causes the device to:
determine whether a transmission time interval (TTI) that includes joint transmission (JT) traffic for a first UE also includes non-JT traffic for a second UE; and
in response to a determination that the TTI includes the non-JT traffic for the second UE:
refrain from transmitting the JT traffic to the first UE during the TTI;
select a codeword for transmission of the non-JT traffic to the second UE; and
transmit, based on the selected codeword, the non-JT traffic to the second UE during the TTI while applying opportunistic nulling towards the first UE.

20. The non-transitory computer readable medium of claim 19, wherein the computer program includes program code, that when executed by the processor of the device, causes the device to:
receive a PMI codeword reported by the second UE;
down select codewords from a first codebook to determine a second codebook; and
identify a codeword from the second codebook having a highest correlation to the PMI codeword reported by the second UE as the selected codeword.
